(19) United States
(12) Patent Application Publication
(10) Pub. No.: US 2024/0116786 A1
(43) Pub. Date: Apr. 11, 2024

(54) IN-SITU METHODS FOR BIODEGRADING CYANOBACTERIA AND THEIR CYANOTOXINS AND REMOVING POLLEN IN A WATER BODY

(71) Applicant: P-Pod Technologies, LLC, Amesbury, MA (US)

(72) Inventor: Jonathan B. Higgins, Amesbury, MA (US)

(21) Appl. No.: 18/485,127

(22) Filed: Oct. 11, 2023

Related U.S. Application Data
(60) Provisional application No. 63/415,153, filed on Oct. 11, 2022.

(51) Int. Cl. C02F 1/52

(52) U.S. Cl. CPC C02F 1/52; C02F 2201/002; C02F 2203/006

(57) ABSTRACT

Methods for in-situ biodegrading cyanobacteria, cyanotoxins, tree pollen and other nutrients in a water body are described. A biodegradation apparatus for performing the biodegradation method is also described. The biodegradation products can be composted. The methods and apparatus can be performed in water body bulk processing mode or water body maintenance mode.

### RELATED APPLICATION

This application claims the benefit of U.S. Provisional Application No. 63/415,153 filed on Oct. 11, 2022. The entire teachings of the above application are incorporated herein by reference.

### BACKGROUND

Cyanobacteria algal blooms, pollen and elevated nutrient content are real problems for many water bodies and make the water bodies unhealthy for aquatic life and recreational purposes. There is a need to control pollen and cyanobacteria in water bodies.

### SUMMARY

The disclosure is directed to methods for in-situ biodegradation of cyanobacteria and reducing their cyanotoxin levels, in a water body, comprising deploying an enclosable, floating biodegradation apparatus in a water body itself, attached to or adjacent to another floatable or fixed-position apparatus, wherein the biodegradation apparatus is configured for biodegrading and facilitating the removal of cyanobacteria from a water column or a targeted water column depth interval in a water body. The cyanobacteria are captured and transferred from the water body to the biodegradation apparatus. The cyanobacteria are held in a small volume of water in the biodegradation apparatus from the water body for a period of time and under the environmental conditions of the water body to induce an in-situ biodegradation process. Due to crowding of the cyanobacteria, the cyanobacteria are more susceptible to being infected by naturally occurring bacteria and viruses and as such readily biodegrade. The cyanotoxins released by the biodegrading cyanobacteria are also biodegraded. The biodegradation products can be housed in the biodegradation apparatus until they are ready to be removed by the user. Degradation products can be reused or disposed of by commercially available methods including additional land-based composting, as a natural fertilizer or disposed of as a waste product in a controlled manner.

Also described is a floatable biodegradation apparatus for collection and biodegradation of cyanobacteria in-situ in a water body. The biodegradation apparatus also serves as a floatable storage container for the biodegradation products. The biodegradation apparatus is comprised of a storage area with sidewalls, base, an open top, floatation member, an optional removable cover to enclose the open top, and side opening for transfer of solids and fluid into and out of the storage area. The biodegradation apparatus can be constructed of one or more layers of permeable to impermeable continuous film, fabric or rigid materials and forming a sealable container fitted with an upper floatation member with attachment points for fixing the apparatus in place and to other apparatus or parts when deployed in surface water. In an embodiment, the biodegradation apparatus further comprises an opening to the water body and the storage area to allow water to flow into the storage area. This feature allows for the capture and transfer of cyanobacteria and other solids from the water body into the storage area of the biodegradation apparatus.

The methods and biodegradation apparatus of the disclosure can be used to reduce solid volume and toxicity of cyanobacteria, leading up to and/or during a cyanobacteria bloom or deployed in a water body for longer periods of time for removing cyanobacteria and pollen, depending on the conditions of the water body and access to the water body to maintain the ecological balance of the water body.

The methods and biodegradation apparatus can be used to reduce pollen contamination on the surface of and within the water body, alone or in conjunction with reducing cyanobacteria, according to the methods of this disclosure. Accordingly, in-situ collection and biodegradation of pollen using the biodegradation apparatus, in a water body, can reduce or minimize cyanobacteria blooms from occurring. The biodegradation apparatus can be deployed in areas with high pollen loads in the water body. Removal of the pollen will remove important nutrients that fuel cyanobacteria blooms. As cyanobacteria feed on the pollen, the method and biodegradation apparatus will also remove cyanobacteria and its cyanotoxins.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is side view of an embodiment biodegradation apparatus with a cover and a side opening (closed).

FIG. 1B is the top view of an embodiment biodegradation apparatus without a cover.

FIG. 1C is a side view of an embodiment biodegradation apparatus with a cover and with a side opening (open) and attachment points.

FIG. 1D is a top view of an embodiment biodegradation apparatus with side opening (open) showing attachment to another apparatus, a dock in this instance.

FIG. 1E shows a plurality of biodegradation apparatuses with covers, side openings (closed), flaps and attachment points. The side openings are in the closed position during the biodegradation process. This embodiment can be preferentially used in the bulk removal mode when more cyanobacteria and pollen need to be handled/processed.

### DETAILED DESCRIPTION

Cyanobacteria (also known as blue green algae), their toxins and sources of excess nutrients for them, including from tree pollen, will eventually negatively impair water quality and uses unless solids (cyanobacteria, pollen, etc.) can be efficiently removed and controlled. The methods and biodegradation apparatus of the disclosure do that by taking and storing solids (cyanobacteria in particular), while processing in a controlled and secure manner by biodegradation under naturally occurring biological conditions. This is a more efficient and safer process, which is particularly important for common and ongoing circumstances of nutrient loading to water bodies such as from tree pollen. Pollen is well suited as a source of nutrients to cyanobacteria as it (the pollen) contains elevated concentrations of the same nutrients that cyanobacteria contain, and tree pollens typically enters water bodies early in the season when other nutrient sources are often more limited. Cyanobacteria are also able to readily biodegrade the pollen to obtain their nutrients.

The number of pollen days and volume of pollen per day have also been increasing with climate change (increasing temperatures and carbon dioxide concentrations) as well as restoration of forest canopies proximate to water bodies. As such, there is a need to control and remove cyanobacteria and the natural sources of nutrients, such as tree pollen, from water bodies.

The present disclosure pertains to a biodegradation apparatus and methods for biodegrading cyanobacteria in-situ and reducing their cyanotoxin levels. The method uses an enclosable and floatable biodegradation apparatus that is deployed in a water body by itself, attached to or adjacent to another floatable or fixed-position apparatus, for the removal of cyanobacteria and cyanotoxins from a water column or targeted water column interval in a water body. The biodegradation apparatus can also be used to remove suspended solids from the water body, in particular tree pollen which serves as a nutrient source for the cyanobacteria.

The biodegradation apparatus can be used to: initially remove and process large, bulk amounts of cyanobacteria often present after years of nutrient addition and growth of cyanobacteria in a water body; followed by ongoing maintenance use for recurring but lessor amounts of cyanobacteria and nutrients added to water bodies by annual tree pollen deposition. The biodegradation apparatus can be deployed seasonally to address cyanobacteria blooms or during high pollen volume/count (bulk processing mode) or it can be deployed for longer periods of time in the water body to passively maintain the ecological balance of the water body (maintenance processing), such as in remote water bodies that are difficult to access. The terms “bulk” and “bulk mode” as used herein are intended to cover conditions in the water body when there is a great deal more biomass and biovolume of cyanobacteria or tree pollen to remove by the methods and biodegradation apparatus. These bulk amounts can build up over many years but they can occur in large volumes over a short period of time during the height of tree pollen season or during a cyanobacteria bloom. “Non-bulk” is defined herein to be the period of time on the water body when the bulk cyanobacteria and pollen load has been removed or biodegraded according to this disclosure, or after the tree pollen season is over. During the non-bulk period of time, the methods and biodegradation apparatus can be operated in maintenance mode.

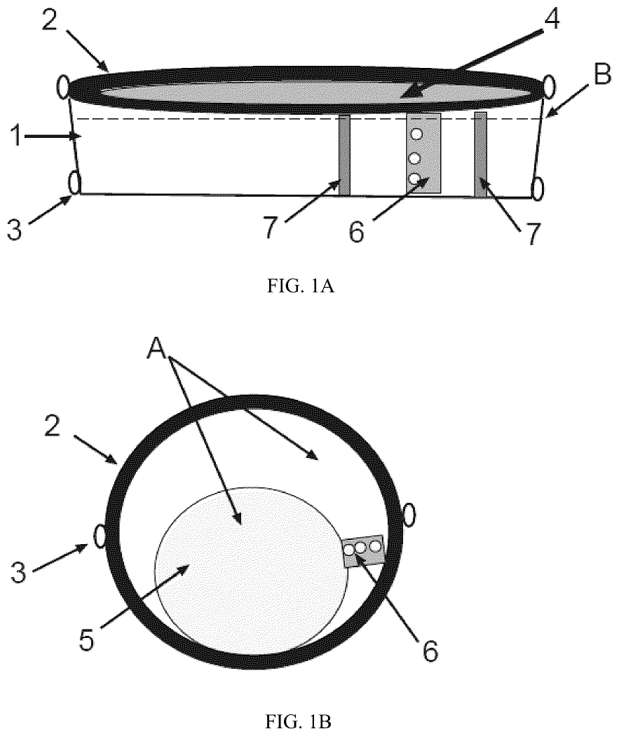

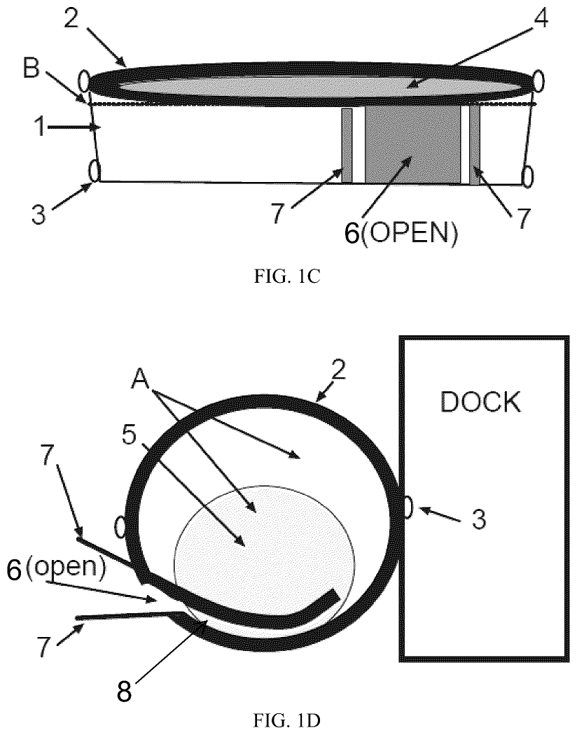

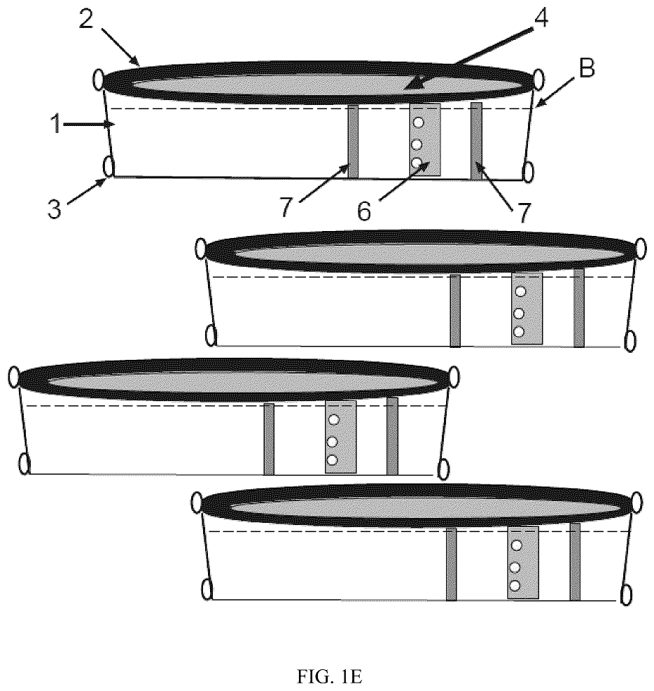

The biodegradation apparatus and methods will be discussed in reference to non-limiting FIGS. 1A, 1B, 1C, 1D and 1E. The figures illustrate example embodiments showing the side views and top views of the biodegradation apparatus.

The biodegradation apparatus has a cylindrical-shaped and/or rectangular-shaped storage area (A) define by sidewalls (1), a base (5) and optional cover (4), the biodegradation apparatus being constructed of one or more layers of permeable to impermeable, continuous film, fabric, or rigid materials integrally formed or connected to each apparatus. The storage area (A) of the biodegradation apparatus also reduces the time and effort needed to physically remove the cyanobacteria, cyanotoxins, and related nutrients and sources such as tree pollen solids either before or after biodegradation process takes place because the degradation process occurs in-situ in the water body. When the cover (4) is positioned on the open top of the biodegradation apparatus, it can augment the biodegradation process. Further, it can provide a barrier to wildlife, such waterfowl and fish, and other animals, such as dog, from coming into contact with the cyanotoxins in the storage area.

The biodegradation apparatus has a floatation member (2). In an embodiment, the biodegradation apparatus will have an upper, tubular floatation member (2) constructed of water resistant and air resistant continuous film or fabric that can be inflated with gas or filled with solid floatation material inserts to provide buoyancy to the biodegradation apparatus. Seams of the floatation member can be sewn, heat sealed, radiofrequency sealed, and/or adhesive sealed to minimize loss of floatation capacity. The floatation member can be integrally formed, fixed to or detachable from the apparatus. The floatation member can be a single floatation member that extends around the entire upper perimeter of the biodegradation apparatus. Alternatively, the floatation member can comprise a plurality of floatation units arranged at intervals around the upper perimeter of the biodegradation, such as evenly separated intervals, or random intervals. Other floatation member designs can be use with the biodegradation apparatus for the purpose of maintaining buoyancy and functioning of the biodegradation apparatus in the water body.

The upper floatation member and sidewalls of the biodegradation apparatus can be designed with attachment points (3) and/or flaps (7) to secure the biodegradation apparatus to other structures, such as barriers to restrict animals and people from access to the biodegradation apparatus. Depending upon state and municipal regulations, restricted access areas may be required. In some embodiments, the attachment points are loops. The number and size of the attachment points and/or flaps will depend on the size of the biodegradation apparatus, wind and water currents, and other external factors that can influence the biodegradation apparatus design.

Drawstrings (B), as illustrated in FIGS. 1A and 1C, are provided as an optional feature and can be made of rope or cable integrally formed within the upper portion of the sidewalls. The top section of the biodegradation apparatus can be rapidly sealed by cinching back the drawstrings (B) and opened to facilitate movement, additions to, or release of the biodegradation apparatus contents.

Porous substrate or mesh screens can be placed in the interior of the biodegradation apparatus to facilitate storage, processing and removal of cyanobacteria, cyanotoxins, pollen and their degradation products and solids from fluid. “Solids” as defined herein include but are not limited to cyanobacteria, degradation products from the decomposition of cyanobacteria, pollen, degradation products from the decomposition of pollen, other solid forms of nutrients in the water body, such as fragments of plants, insects, or phytoplankton. Solids include cyanobacteria and related nutrient sources such as tree pollen prior to, during and after biodegradation within the Storage Area (A). Biodegradation of these solids reduces their overall volume and mass and as such, results in less maintenance and related costs to remove these solid sources from water bodies.

Cyanobacteria, pollen and fluid can be added to the storage area (A) through the open top of the biodegradation apparatus. Cyanobacteria, cyanotoxins, pollen and their degradation products and solids can be removed from the storage area (A) through the open top of the biodegradation apparatus.

In alternative embodiments, the biodegradation apparatus has a side opening (6) for transfer of solids and fluid into or out of the storage area (A). See FIGS. 1A, 1B, 1C and 1D. As seen in FIG. 1A (shown in the closed position), the side opening (6) is provided on the outside of the sidewall and an interior side opening (6) as illustrated in FIG. 1B (shown in the closed position), both the inside and outside side opening are in fluid communication with each other, to create a flow pathway, as illustrated in FIG. 1D. A side opening to the apparatus allows for transfer of water containing cyanobacteria and similar solids such as pollen into the Storage Area without the required use of pumping equipment to transfer water and solids above the water surface and into the storage area. In this non-pumping alternative, a propeller or air-jet or similar means of inducing or using natural water flows could be used to move water with solids sideways or laterally from the water body and into the Storage Area (A). The Storage Area itself can be configured to promote rotation and containment of entrained solids in water. The side opening (6) also assists in containment of cyanobacteria when they are co-located with larger debris such as leaves, plant matter and twigs which would otherwise restrict or clog pumping equipment. These larger solids could then be removed by the user from the interior of the Storage Area using nets and similar on a less frequent basis than unclogging pumping equipment would require. The storage area of the biodegradation apparatus will be sized depending upon the biomass of cyanobacteria added. In some embodiments, the biodegradation apparatus will have a storage area of from about 5 feet to about 10 feet in diameter by up to about 3 feet deep. In embodiments, a small volume will be from about 400 to about 2,000 gallons of water in the storage area of the biodegradation apparatus. In other embodiments, for large water bodies, the the biodegradation apparatus will have a storage area of about an acre or more.

Attachment loops (3) and/or flaps (7) can be situated along the perimeter of the biodegradation apparatus to serve as anchor or attachment points. In operation, the biodegradation apparatus can be floated, moved and deployed in selected areas of a surface water body. The biodegradation apparatus can also be anchored or attached to a fixed or floating structures to maintain its location and function within a surface water body. In an embodiment as illustrated in FIG. 1D, the biodegradation apparatus is attached to a dock with the side opening (6), shown in open position and flaps (7) flanking the opening (6) extending outward to help direct water flows and solids into the storage area (A).

In an embodiment, as illustrated in FIG. 1C and FIG. 1D, provided is an enclosable, floating biodegradation apparatus comprising a storage area (A) with sidewalls (1), a closed bottom (base) (5) and an open top (shown with a cover in FIG. 1C), a floatation member (2), an optional removable cover (4) to enclose the top, and an opening (6) to the water body for transfer of solids and fluid into the storage area, wherein the opening to the water body is a curved flow pathway (8) extending along at least a portion of the inner wall of the storage area (A) and open to the interior of the storage area. In one embodiment, the portion of the flow pathway that extends along the inner curved wall has a generally rectangular cross section, with a height greater than the width. In another embodiment, the biodegradation apparatus can comprise flaps (7) that flank the opening (6) on the water body end of the pathway. The opening (6) can extend into the water body by extensions, such as flaps or flanges, and by optionally attachable structures that direct fluids and solids into the opening (6), through the pathway and into the storage area of the biodegradation apparatus. These structures can be configured to provide a narrowing pathway into the opening (6). In operation, fluids and solids, such as cyanobacteria and pollen and other nutrients, are directed into the opening by natural flow of water, such as created by wind or water currents, or by directing the fluid and solids flow such as by pumping. The flaps, for example, can be extended into the water body depending upon the level of solids that need to be removed from the water body, such as lengthening the flaps and/or other structures farther into the water body during bulk collection times (bulk mode), or shortening the flaps or and/or other structures closer to the biodegradation apparatus during maintenance collection times (maintenance mode). Examples of extensions can be at least one flange, flap, boom or other structure that can direct fluid and solids flow into the opening. In some embodiments, two extensions that flank the opening are present. Alternatively, at least one of the extensions (e.g., flaps, flanges or other structures) can be affixed to another structure, such as the shoreline, to aid in directing the flow of fluids and solids of interest into the storage area.

In one aspect, a function of the biodegradation apparatus is to provide an easily portable, floatable and scalable means to securely store and process cyanobacteria from fluid of a surface water body and the water column or an interval of a water column where the cyanobacteria can be found in the water body. In this aspect, cyanobacteria can be removed from the water body, decomposed in-situ in the biodegradation apparatus and the degradation products, including biodegradation of cyanotoxins, can be collected and optionally composted, reused as a natural fertilizer or similar beneficial reuse or disposed of on land.

In another aspect, the biodegradation apparatus provides an easily portable, floatable and scalable means to securely store and process tree pollen, and other nutrient sources that can fuel cyanobacteria growth from fluid of a surface water body. Sources of nutrients to cyanobacteria can be but are not limited to tree pollen falling directly in a water body or carried into a water body with storm water or stream flow or it can be, from other plant materials, insects, or dissolved nutrients entering a water body with septic wastes, wet deposition with precipitation, or erosion. In an embodiment, removal of tree pollens, in particular, can reduce and even prevent cyanobacteria growth in the water body by reducing or eliminating an important annual nutrient source for cyanobacteria. When collected in the biodegradation apparatus, the pollen can be biodegraded and consumed by the cyanobacteria and other bacteria and viruses in the water being held in the biodegradation apparatus. The degradation solids produced by decomposition of pollen and undegraded pollen can be collected and optionally composted, beneficially reused or disposed of on land.

In yet another aspect, in addition to in-situ biodegrading cyanobacteria, cyanotoxins, pollen, and other nutrient sources for cyanobacteria in the biodegradation apparatus, the biodegradation apparatus can also be used to allow for the targeted alteration of physical, biological or chemical properties of fluid and solids within the biodegradation apparatus, to assist with or augment the separation and removal of the solids from fluid by degradation, sorption, settling, floatation or filtering. Commercially available and proprietary flocculants, coagulants, biological, chemical substances and mixtures and coatings, physical alternations, dissolved and dispersed gas injection, and directional pumping or injection of fluids, gases, and fluid-gas mixtures can be used to increase the effectiveness of the solids separation, processing and removal by the biodegradation apparatus.

In another aspect, an auxiliary function of the biodegradation apparatus is to provide safe storage and handling of biotic species, such as but not limited to algae, phytoplankton, zooplankton, shellfish, insects and animals and their larvae or offspring in a manner which minimizes their disturbance, predation, or harm and allows for controlled propagation and release of the biotic species back to the surface water.

### In-Situ Biodegradation

A method of using the biodegradation apparatus is disclosed for in-situ biodegradation of collected cyanobacteria. According to the method, cyanobacteria are placed in the biodegradation apparatus, optionally adjacent or attached to another apparatus, for capturing and removing cyanobacteria from a water column or targeted water column interval containing the cyanobacteria in a water body. The biodegradation apparatus is designed to hold the cyanobacteria in a small volume of water from the water body for a period of time and under the environmental conditions of the water body. The method is performed in-situ, that is the apparatus is deployed in the water body to take advantage of the temperature of the water body and the climate of the surrounding water body. As the biodegradation process takes place, the cyanobacteria die, the cells lyse and release their cell contents including carbohydrates, and cyanotoxins into the volume of water in the biodegradation apparatus. The carbohydrates and cyanotoxins are then further biodegraded to produce relatively inert biodegradation products consisting primarily of elemental nutrients and carbon.

The water containing the collected cyanobacteria can be transferred to the biodegradation apparatus by conduit, pump or other transfer means through the side opening or into the top opening. Once the cyanobacteria are transferred to the biodegradation apparatus, the increased concentration of cyanobacteria in a given volume of the biodegradation apparatus hinders the cyanobacteria from natural separation from each other (the space that they normally have in the open surface water body) and crowds the cyanobacteria which also creates stress on the enclosed cyanobacteria population. Containment of cyanobacteria (cells) within the Storage Area forces the cyanobacteria cells closer together which allows naturally occurring bacteria and viruses to more readily biodegrade and consume cyanobacteria and cyanotoxins than in non-contained areas of a water body. This biodegradation results in an approximately 85 percent reduction in cyanobacteria biovolume and destruction of cyanotoxins within several days to a week under favorable conditions (water temperature, dissolved oxygen and reduction of sunlight to the cyanobacteria under the apparatus' cover over the Storage Area). The reduction in normal separation and stress placed on the cyanobacteria allows bacteria and viruses naturally present in the water volume to consume and biodegrade the cyanobacteria and their cyanotoxins.

Fluid containing cyanobacteria from a surface water and the water column where they reside can be added to, or removed from, the apparatus using dedicated or mobile fluid pumping or transfer equipment such as pumps. Once contained in the biodegradation apparatus, fluid with solids can be processed using fixed or mobile equipment such as pumps or aerators to facilitate either removal of solids and fluids, the addition of treatment fluids and gases to promote biodegradation, mixing, settling or floatation of solids and their contents or for maintaining water quality for the health of biotic solids such as zooplankton. Fluid within and effluent from the apparatus can be further processed by filtration to remove additional total and dissolved solids.

The in-situ biodegradation of cyanobacteria using the methods and apparatus of the disclosure allow for rapid biodegradation of cyanobacteria in a way that minimizes handling or energy (pumps) by the user. The in-situ biodegradation of cyanobacteria helps to reduce the volume of cyanobacteria degradation solids and their cyanotoxins, so the end product (biodegraded) solids in the biodegradation apparatus would have both less volume and less to no cyanotoxins. The in-situ biodegradation process requires less maintenance/removal over time compared to ex-situ methods of removing and handling/reuse/disposal of cyanobacteria.

The in-situ biodegradation method utilizes naturally occurring conditions in the water body including water temperature, dissolved oxygen, and cyanobacteria still suspended in water that can be readily mixed and settle out as biodegradation products. This forced concentration of cyanobacteria in the storage area of the biodegradation apparatus provides favorable conditions for naturally occurring types of bacteria and viruses that can rapidly biodegrade, destroy, and consume the cyanobacteria and their cyanotoxins.

The biodegradation process converts the cyanobacteria to a much smaller biovolume and biomass, essentially a high-nutrient and carbon containing, ash-like residue that is much easier to permanently remove from the water body than ex-situ cyanobacteria removal and land-based biodegradation. It is a lot more efficient to leverage naturally occurring conditions to concentrate and biodegrade cyanobacteria than to create, force and manage similar conditions ex-situ. Some water bodies are also less conducive to ex-situ treatment due to limited access or supporting infrastructure or the amount of cyanobacteria in bulk to remove or large size of a water body and location(s) of cyanobacteria containment and removal areas.

Field research by the inventor has documented that as cyanobacteria are concentrated within a confined, storage area while still in the water body, they are rapidly biodegraded by aerobic bacteria and likely other natural occurring bacteria and viruses that in turn, have evolved to utilize cyanobacteria as a food (carbohydrates and starches most likely) source. The inventor refers to this process of containing and concentrating the cyanobacteria as removing their natural “social distancing” enough so that naturally occurring bacteria and viruses can proliferate and readily biodegrade the cyanobacteria. Under non-confined and concentrated, often natural water body conditions, the cyanobacteria cells maintain similar electrical surface charge polarity, a slight negative charge produced by photosynthesis primarily, that keeps the cells separated from each other and less likely for them to be colonized by naturally occurring bacteria and viruses. The ability to be biodegraded by bacteria or infected by viruses is directly related to reduction in spacing between cyanobacteria cells.

During containment and biodegradation of bulk amounts of cyanobacteria, the dissolved oxygen concentration within the storage area drops, the water within the contained area can turn a blueish-green or cyan color as cyanobacteria cells are ruptured and decompose, and field and laboratory readings for phycocyanin (PC) (a biochemical component essentially unique to most freshwater cyanobacteria) drops rapidly in concentration. A similar drop in phycoerythrin (a biochemical component unique to most estuarine and marine cyanobacteria) would also likely drop in concentration in marine water applications of this biodegradation apparatus and biodegradation process. Water color changes (from clear to cyan to clear again) are a good visual metric for the initiation and completion of biodegradation processes over time for bulk amounts of cyanobacteria placed within the storage area. Based on sequential laboratory analysis over time, cyanotoxins, another readily biodegradable organic chemical component of cyanobacteria, also rapidly drop in concentration. Field, laboratory and color changes document that the biodegradation process, in-situ, is a very rapid process being complete within several days to a week. The cyanobacteria content and biodegradation process in the storage area can be tested by commercially available field and laboratory sampling and analysis as well as visual methods to determine the status and progression of the biodegradation process. As the biodegradation process nears completion, the water clarity in the biodegradation apparatus will improve.

In-Situ Pollen Removal from the Water Body

Pollen deposited into a water body, from for example trees, possess a nutrient content that fuels cyanobacteria growth. This is a growing problem due to the increasing number of high tree pollen count days compared to years past, likely caused by global warming. Tree pollen can be a significant external source of nutrients to a water body that can fuel cyanobacterial growth. It has been demonstrated, that physically removing the external source of nutrients, that is removal of the tree pollen, from the water body can stop the annual recurring cyanobacteria algal bloom cycle in some water bodies.

According to this discovery, an embodiment of the disclosure provides methods for collection and concentration of pollen in the biodegradation apparatus from fluid within a water body which minimizes time and effort to remove this source of nutrients to cyanobacteria by the user from the water body. Biodegradation of nutrient sources such as tree pollen, including cyanobacteria and cyanotoxins within the biodegradation apparatus further concentrates and reduces the volume of these substances (tree pollen and cyanobacteria) requiring removal. Removal of tree pollen and cyanobacteria from a water body is a best management practice to control and remove these sources that would otherwise impair water quality of a water body.

### Water Body Bulk Processing Mode

The methods and biodegradation apparatus of the disclosure can be used to reduce large amounts or bulk solid volume and toxicity of cyanobacteria, leading up to and/or during cyanobacteria blooms. The biodegradation apparatus can be used to initially remove and process large, bulk amounts of cyanobacteria often present after years of nutrient addition and growth of cyanobacteria in a water body.

### Water Body Maintenance Mode

Under non-bulk, low concentrations of cyanobacteria in a water body and related additions to the storage area of the biodegradation apparatus, the biodegradation process still occurs but it is a gradual process suitable as a best management practice for water bodies to keep cyanobacteria from being a future health risk and significant water quality impairment.

Naturally occurring bacteria and viruses that remain present in the apparatus's storage area would continue to degrade cyanobacteria as it enters over time. Under these non-bulk concentrations of cyanobacteria added to the biodegradation apparatus storage area, water color changes have not been visually apparent, and sequential field and laboratory results over time remain low for cyanobacteria and their cyanotoxins even with new additions of non-bulk concentrations of cyanobacteria. As such, it is a gradual biodegradation process that keeps cyanobacteria and cyanotoxins removed from a water body from building up over time in the biodegradation apparatus storage area. At the end of each cyanobacterial season which will vary by geographic region and type(s) of cyanobacteria present in a water body, the nutrient-rich residual solid in the biodegradation apparatus storage area can be removed using commercially available suction pumping, granular activated carbon, sand or bag filters. Final laboratory testing of these residual solids can be used to guide their ultimate use which would include as a natural fertilizer or disposal, or other processing reuse or disposal practices that are readily known by the skilled person. The residues could also be dried out and used with concrete to make park benches or landscape paving stones. In any event, the natural biodegradation process substantially reduces the volume, weight and cyanotoxin content of solids and residuals and as such, reduces the costs, effort and final amount of handling, reuse or disposal involved.

This best management practice application of the biodegradation apparatus can also be used to collect, biodegrade and remove nutrient loading sources, such as tree pollen, that would otherwise be used by cyanobacteria to increase their biovolume, biomass and related health and water quality impacts, if not otherwise controlled. Tree pollen loading is a significant source of nutrients to cyanobacteria in water bodies. The amount of tree pollen produced over the years has also been increasing with increases in temperature and carbon dioxide concentrations associated with global warming and climate changes.

### Biodegradation Products

The biodegradation apparatus and method allow for significant improvements in biodegradation and further decomposition of cyanobacteria and their cyanotoxins while still in the water (after being placed in the enclosed biodegradation apparatus). In-situ biodegradation of cyanobacteria reduces their biovolume (cyanobacteria are about 85% fluid) to an ash-like solid residue. Importantly, cyanotoxins, another biological component of cyanobacteria, also readily breaks down in the biodegradation apparatus. Use of the biodegradation apparatus and the method are quick and easy with benefits of rapid cyanobacteria biomass and cyanotoxin degradation in-situ, while minimizing extra handling, transport, or disposal/reuse concerns.

There is no required composting or land-based biodegradation of in-situ (bio)degradation products. They can be composted if the user wants (as discussed below). The degradation products can be used a natural fertilizer, disposed of or some other suitable/creative reuse or disposal option, even mixing with concrete and making landscape paving stones or park bench ends.

Ex-situ handling and removal of cyanobacteria, cyanotoxins and other substances serving as nutrients (tree pollen in particular) to cyanobacteria require: pumping from the water body to an initial water separation and cyanobacteria drying area; allowing approximately three days for the cyanobacteria to dry out; transport to rotary compost bins for biodegradation (preferably in an area of direct sunlight for thermophilic, aerobic bacterial biodegradation); rotating the compost bins; using new compost bins in sequence as cyanobacteria are removed and added over time; then a final compost pile stage. Laboratory analysis is used to document destruction of cyanotoxin content which takes about one to two weeks with favorable conditions (warm temperatures, aeration of cyanobacteria mass during composting). The overall biovolume and biomass (weight) reduction over time by ex-situ processing is approximately 60 percent and 87 percent, respectively. Some of the biovolume is relatively non-biodegradable organic substances like lignin from plants parts that are also removed with cyanobacteria from a water body.

### Biotic Capture

In another embodiment, the biodegradation apparatus and the biotic storage apparatus can be deployed together or separately, adjacent or attached to an apparatus for capturing and removal of cyanobacteria from a water column interval containing the cyanobacteria in a water body. Biotic species are often collected along with the collection of cyanobacteria and pollen, and safe handling of the biotic species is necessary to maintain the ecosystem of the water body. In an embodiment of this aspect, a biotic container is deployed adjacent to a biodegradation apparatus for capturing and removing cyanobacteria, cyanotoxins, pollen and other solid nutrients in a water column interval containing the cyanobacteria in a water body. The biotic container can house biotic species that are collected and separated from the cyanobacteria and provided a safe environment for them to thrive away from predation by fish, insects, or animals.

A biotic container could be used to grow out and reintroduce some types of biotic species (like large zooplankton) that are otherwise depleted already in a water body, either from cyanobacteria that are toxic to them, or by predation from stocked trout and similar. Some biotic species have been lost or significantly depleted based on cyanobacteria and restoring these and their natural function will help to restore balance (and lack of cyanobacteria regrowth) in water bodies.

While this disclosure has been particularly shown and described with references to example embodiments thereof, it will be understood by those skilled in the art that various changes in form and details may be made therein without departing from the scope encompassed by the appended claims.

What is claimed is:

1. A method for in-situ biodegradation of cyanobacteria and reducing their cyanotoxin levels, in a water body, comprising:
deploying an enclosable, floating biodegradation apparatus in a water body by itself, attached to or adjacent to another floatable or fixed-position apparatus, wherein the biodegradation apparatus is configured for removing cyanobacteria from a water column or a targeted water column depth interval in a water body;
capturing and transferring the cyanobacteria from the water body to the biodegradation apparatus;
holding the cyanobacteria in a small volume of water in a storage area of the biodegradation apparatus in the water body for a period of time and under the environmental conditions of the water body to induce an in-situ biodegradation process, thereby causing the cyanobacteria and their cyanotoxins to biodegrade into degradation products.

2. The method of claim 1, wherein the biodegradation apparatus can further house biotic species from the water body.

3. The method of claim 1, wherein the cyanobacteria can be transferred to the biodegradation apparatus by conduit or pump through a side opening of the biodegradation apparatus or into the top opening of the biodegradation apparatus.

4. The method of claim 1, wherein the biodegradation process is initiated in-situ by crowding the cyanobacteria in the biodegradation apparatus.

5. The method of claim 1, wherein the enclosable, floating biodegradation apparatus comprises a storage area with sidewalls, a closed bottom and an open top, a floatation member, an optional removable cover to enclose the open top, and side opening for transfer of solids and fluid into and out of the storage area.

6. The method of claim 1, wherein the in-situ biodegradation process is augmented by covering the biodegradation apparatus.

7. The method of claim 5, wherein the biodegradable apparatus is constructed of one or more layers of permeable to impermeable continuous film, fabric or rigid materials.

8. The method of claim 5, wherein the floatation member has attachment points for fixing the biodegradation apparatus in place and to other apparatus or parts when deployed in surface water.

9. The method of claim 1, further comprising in-situ degrading the degradation products in the biodegradation apparatus.

10. The method of claim 1, wherein the floating biodegradation apparatus can be used to store and biodegrade large amounts or bulk volumes of cyanobacteria and cyanotoxins from the water body.

11. The method of claim 1, wherein the floating biodegradation apparatus can be used to store and biodegrade small amounts of cyanobacteria and cyanotoxins accumulating over time from the water body.

12. The method of claim 1, wherein the floating biodegradation apparatus can be used to store, biodegrade and remove tree pollen and similar sources of nutrients to cyanobacteria that enter a water body.

13. The method of claim 1, wherein a plurality of floating biodegradation apparatuses can be used together or in sequence to contain, biodegrade and remove cyanobacteria and cyanotoxins from a water body and for removal of external sources of nutrients to cyanobacteria such as tree pollen that enter a water body.

14. A method for in-situ biodegradation of pollen, in a water body, to reduce or minimize cyanobacteria blooms from occurring, comprising:
deploying an enclosable, floating biodegradation apparatus in a water body in an area of pollen load, by itself, attached to or adjacent to another floatable or fixed-position apparatus, wherein the biodegradation apparatus is configured for removing pollen from the surface of a water body;
capturing and transferring the pollen from the water body to the biodegradation apparatus;
holding the pollen in a small volume of water in a storage area of the biodegradation apparatus in the water body for a period of time and under the environmental conditions of the water body to induce an in-situ biodegradation process, thereby causing the pollen to biodegrade into degradation products;
wherein removal of pollen from the water body will reduce nutrient source that fuels cyanobacteria blooms.

15. The method of claim 14, wherein the pollen is tree pollen.

16. The method of claim 15, wherein cyanobacteria will be captured and transferred to the biodegradation apparatus along with the pollen and will biodegrade in-situ.

17. The method of claim 14, wherein the enclosable, floating biodegradation apparatus comprises a storage area with sidewalls, a closed bottom and an open top, a floatation member, an optional removable cover to enclose the open top, and side opening for transfer of pollen and fluid into and out of the storage area.

18. An enclosable, floating biodegradation apparatus comprising a storage area with sidewalls, a closed bottom and an open top, a floatation member, an optional removable cover to enclose the open top, and an opening to the water body for transfer of solids and fluid into the storage area, wherein the opening to the water body is a curved flow pathway extending along at least a portion of the inner wall of the storage area and open to the interior of the storage area.

19. The enclosable, floating biodegradation apparatus of claim 18, wherein the portion of the flow pathway that extend along the inner curved wall has a generally rectangular cross section, with a height greater than the width.

20. The enclosable, floating biodegradation apparatus of claim 18, further comprising flaps that flank the opening of the water body.

21. The enclosable, floating biodegradation apparatus of claim 18, wherein the opening extends into the water body by extensions, flaps or flanges and optional attachable structures that direct fluids and solids into the opening.
